(19) United States
(12) Patent Application Publication
(10) Pub. No.: US 2002/0111936 A1
(43) Pub. Date: Aug. 15, 2002

(54) System and method for analyzing computer intelligible electronic data

(75) Inventors: Steven E. Adams, Dublin, OH (US); Steven R. Zimmerman, Columbus, OH (US); James R. Davee, Clayton, OH (US); Fouzia S. Kiani, Grove City, OH (US)

Correspondence Address: William B. Nash, JACKSON WALKER L.L.P., Suite 2100, 112 E. Pecan Street, San Antonio, TX, 78205, US

(73) Assignee: EC Outlook, Inc.

(21) Appl. No.: 10/008,192

(22) Filed: Dec. 7, 2001

Related U.S. Application Data
(63) Continuation-in-part of application No. 09/767,422, filed on Jan. 19, 2001.
(60) Provisional application No. 60/314,715, filed on Aug. 24, 2001.

(51) Int. Cl. G06F 7/00

(52) U.S. Cl. 707/1

(57) ABSTRACT

The present invention provides a system and method of analyzing electronic data that eliminate the need for externally sourced descriptions, thus reducing the time and expense associated with manual creation of data file descriptive information. The present invention is capable of automatically analyzing one or more incoming data files, generating information descriptive of the structure of each data file and producing output data similar or identical in structure to the incoming data file(s) for use in subsequent applications.

This patent application claims priority from a provisional patent application entitled “System and Method for Analyzing and Describing Electronic Data, and generating Major and Minor Variant Samples of Electronic Data,” Serial No. 60/314,715, having a filing date of Aug. 24, 2001. This patent application is also a continuation in part of another utility patent application entitled “System and Method for Conducting Electronic Commerce,” Ser. No. 09/767,442 having a filing date of Jan. 19, 2001.

### FIELD OF THE INVENTION

The present invention relates generally to a system and method of analyzing electronic data and, more particularly, to a system and method of determining the inherent structure of one or more incoming data files and generating output data for use in retrieving or testing electronic data.

### BACKGROUND OF THE INVENTION

The need for the efficient analysis of electronic data has become increasingly important as reliance upon computer systems has increased. Electronic data, regardless of its type, benefits from descriptive information capable of identifying and characterizing the individual data elements of incoming data files. To illustrate, information describing the starting position, length, delimiting character, etc., of individual data elements allows a database management system or other system to more efficiently read and utilize an incoming data file.

The analysis of electronic data files requires descriptive information, whether found within the data file or sourced externally, to identify and describe each data element. For example, descriptive information allows database management systems to more efficiently extract data, extract specific subsets of data, convert identified data into other formats, import data from other systems and/or prepare external systems to utilize the incoming data file. If descriptive information is not available, efficient use of the incoming data file is extremely difficult.

Typically, known systems utilize defined data formats to provide descriptive information for electronic data files. Defined data formats, such as xBase, Excel, EDI or XML, contain descriptive information which may be used to identify individual data elements of an incoming data file. Data files having a defined format are typically referred to as structured files.

Although equipped with a predefined format, structured files such as EDI and XML are often equipped with one or more implementation guides. These implementation guides provide additional descriptive information for each element of the structured data file.

Some electronic data is produced without the benefit of a predefined format. This type of electronic data is referred to as semi-structured data and is typically organized in a manner such that individual data elements may be identified through data analysis. Specifically, the position of individual data elements or the presence of delimiting characters within the semi-structured file may be used to identify and describe the structural characteristics of each individual data element. The organization of the data in this manner typically requires a painstaking process by the owner of the data during extraction. Unfortunately, the process of organizing the data held within each data file is time consuming and expensive.

### SUMMARY OF THE INVENTION

Accordingly, the present invention provides a system and method of analyzing electronic data that eliminates the need for externally sourced descriptions, thus reducing the time and expense associated with manual creation of data file descriptive information. The present invention is capable of automatically analyzing one or more incoming data files, generating information descriptive of the structure of each data file and producing output data similar or identical in structure to the incoming data file(s) for use in subsequent applications.

### BRIEF DESCRIPTION OF THE DRAWINGS

FIG. 1 is a component diagram of one embodiment of the present invention.

FIG. 2 is a flowchart of the data analysis process for structured data files of one embodiment of the present invention.

FIG. 2A is a flowchart illustrating a portion of the record break analysis process of one embodiment of the present invention.

FIG. 2B is a flowchart illustrating a portion of the field break analysis process of one embodiment of the present invention.

FIG. 3 is a flowchart of the data analysis process for semi-structured data files of one embodiment of the present invention.

FIG. 4 is an illustration of structured data file hierarchical representations of one embodiment of the present invention.

FIG. 5 is an illustration of semi-structured data file hierarchical representations of one embodiment of the present invention.

FIG. 6 is a flowchart illustrating a portion of the output generation process of one embodiment of the present invention.

### DETAILED DESCRIPTION OF THE INVENTION

The present invention is herein described as a computer implemented method of analyzing electronic data, as a computer readable medium comprising a plurality of instructions for analyzing computer intelligible electronic data and as a computer system for analyzing electronic data. Referring to the Figures, the present invention is capable of analyzing electronic data to determine the structural characteristics of the data. The structural characteristics may then be used to generate output data comprising a structural map of the incoming data for use in a variety of applications.

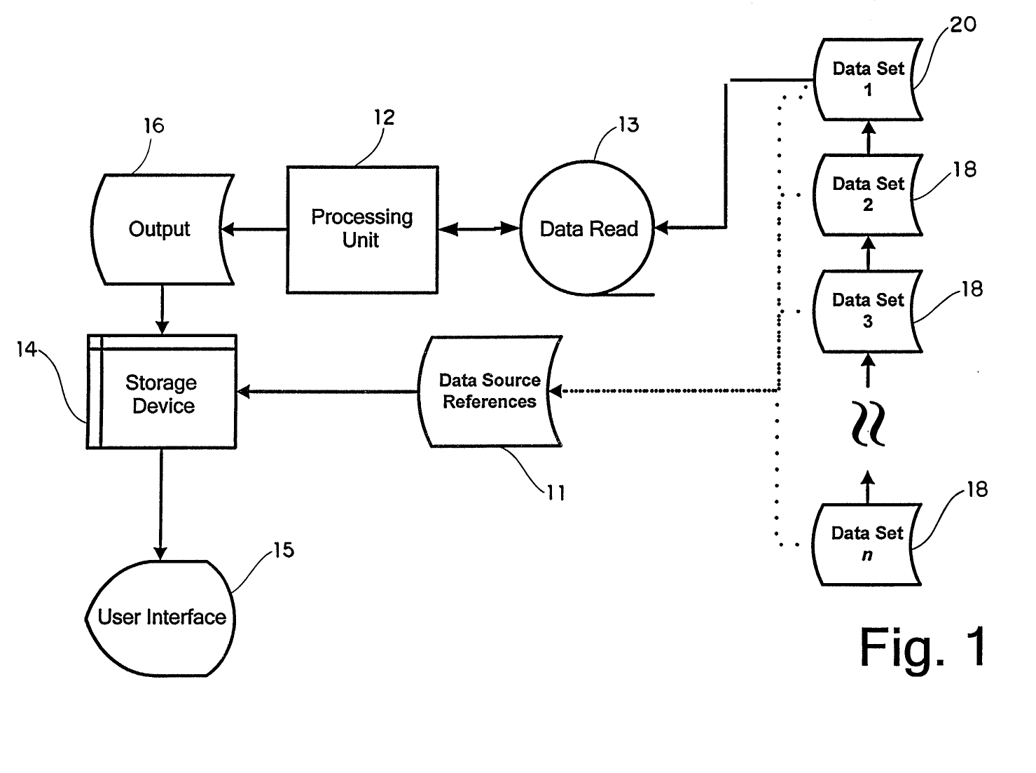

Referring to FIG. 1, the present invention is equipped with a processing unit (12) capable of reading and analyzing computer intelligible electronic data, as illustrated by Box (13). In one embodiment, the present invention provides a storage device (14) electrically coupled to the processing unit (12). In another embodiment, the present invention provides a user interface (15) through which the user may view and/or modify output data (16). In one embodiment of the present invention, only references to the source of output data (16) are stored within the storage device (14). Specifically, the analyzed data files (20) themselves need not be stored, as illustrated by Box (11) of FIG. 1.

The present invention is highly versatile and may be used with a variety of hardware platforms. For example, the present invention may be used with a host of personal computers and mid-range computer platforms (not shown). Platform specific code may be generated for Windows, Solaris, Linux, and Hewlett Packard HP-UX operating systems, if desired.

Any media type or environment supported by the operating system and hardware platform, whether local to the system or over a network, may be used by the present invention. For example, direct access storage devices (DASD), write-once read-many devices (WORM), directly accessible tape and solid state devices (SSD), single or multiple read/write head, redundant array (RAID of any level), or jukebox subsystems may be utilized by the present invention. The present invention is capable of efficient operation without the use of proprietary media formats, hidden partitions, or any other storage media preparation in addition to that required and/or supported by the operating system and hardware platform on which the present invention is installed.

The present invention is capable of efficiently analyzing incoming data (20) regardless of its type or structure. In one embodiment of the present invention, the term “data” is used to describe actual characters or values such as a name (e.g. John Smith) or date (e.g. May 7, 2001) stored in a computer intelligible format. In another embodiment, data is accumulated into files (20). Files (20) may take the form of a computer data file, a computer application, or any data input stream or data collection introduced from an outside application or system. In one embodiment, these files (20) may be divided into records (22) comprising a physical or logical division of the file (20) into one or more sets of characters. In another embodiment, individual data elements retaining some characteristic or value in addition to their simple character contents are referred to as a field (24). For example, “2001” could be classified by value, year, and/or street number fields, depending upon its intended use.

In one embodiment, the structure of the incoming data (20) is determined by analyzing the syntactic and semantic characteristics of the incoming data. In one embodiment, syntax refers to the physical characteristics of the fields (24) and/or records (22) present within the incoming data files. For example, if a given field (24) contains the data “2001”, syntax would include a length of four characters of the numeric type. Syntax may also include the field's position within the record as compared to other fields as well as the number of fields (24) in a record (22), the accumulated character lengths of each field and record's position within an electronic data file (20) as compared to other records. Additionally, syntax may include the overall file size, the creation date, the last modified date and the number of records (22) in the file (20). Syntax may also be used as a validation test for data, as discussed below.

In one embodiment, semantics refers to the attribute characteristic values of a field (24), record (22) or file (20). For example, is a given field (24) contains the data “2001”, semantics may take the form of a “year” definition to describe the data and may also include definitions such as “Ordered Items” or “Shipping Information”, depending on the type of data at issue. For any given data file (20), semantics may include broad definitions such as “Company X Purchase Order” or “XML Transaction Database”. Semantic information is typically provided by the user upon creation of the field (24), record (22) or file (20) at issue.

Data Analysis

The present invention is capable of receiving and analyzing one or more incoming data files (20) to produce output data (16) capable of providing a concise description of the structural characteristics of the incoming data (20). Data files to be analyzed are collected through a reading process, as illustrated by Box (13) of FIG. 1. In one embodiment, incoming data files (20) are not imported or otherwise modified from their original state but are simply read by the processing unit (12) of the present invention for analysis.

Although the present invention is capable of reading and analyzing individual electronic data files (20), it may be advantageous to combine substantially similar data files (18) for simultaneous analysis. Data files may be substantially similar in content and/or structure in that the files have at least one common characteristic. For example, electronic purchase orders and electronic invoices used by Company X, although distinct types of data files, may contain commonality. By analyzing similar files (18) simultaneously or as a continuous stream of data, the processing unit (12) of the present invention is capable of determining the structural characteristics of the electronic data files with greater accuracy. In short, a large number of files (18 and 20) having some degree of commonality will provide the system with additional examples of those possible structural configurations for the files, thus refining the analysis process.

Once similar data files (18 and 20), if any, have been grouped for reading the processing unit (12) of the present invention is designed to automatically identify each electronic data field and its associated structural data.

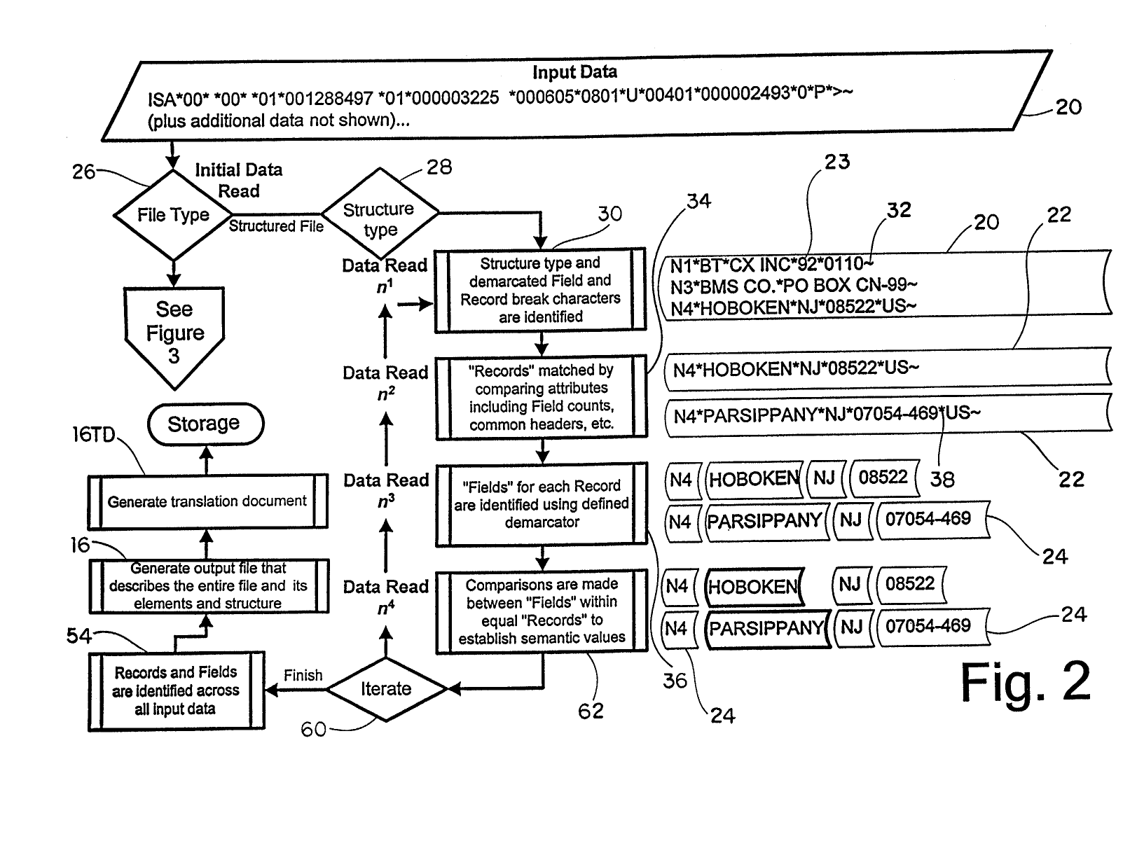

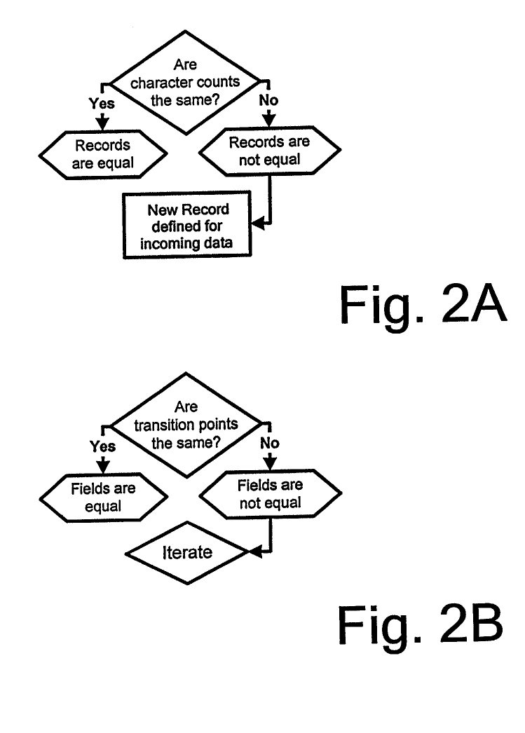

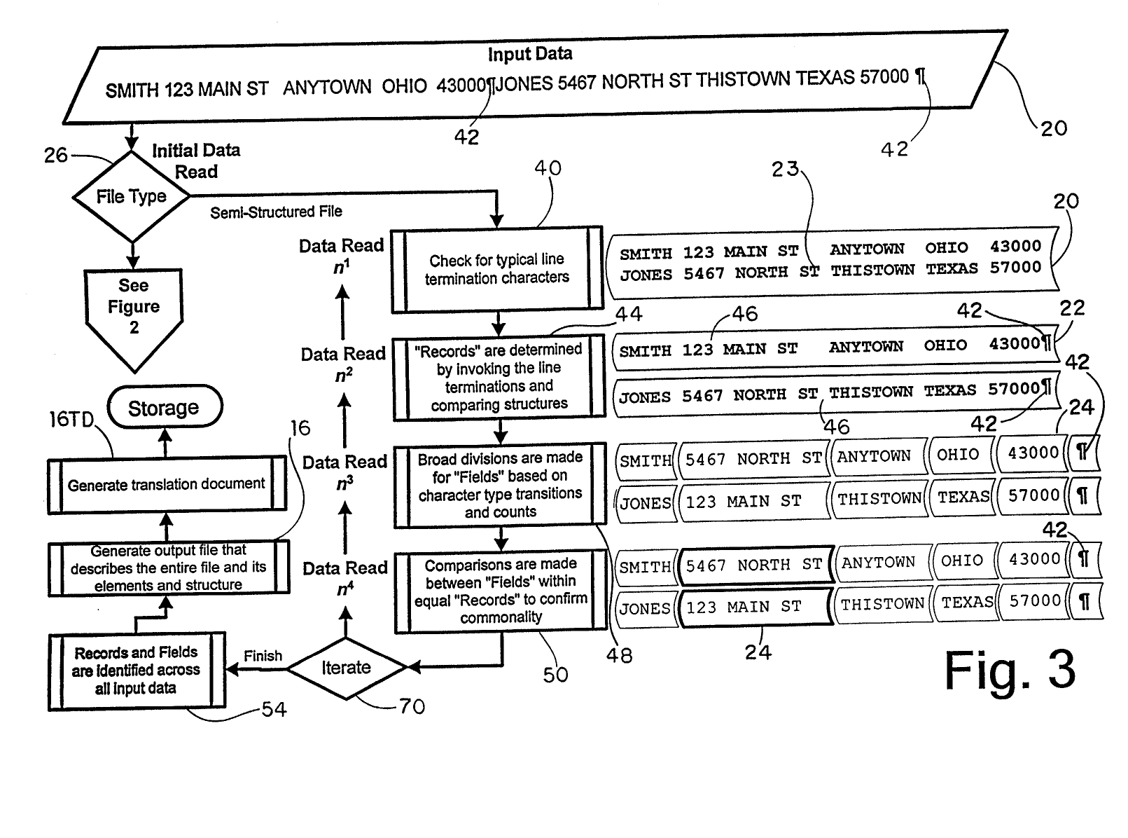

The system, upon reading electronic data, identifies the file type associated with the incoming electronic data file(s) (20) as illustrated by Box (26) of FIGS. 2 and 3. In one embodiment, the present invention identifies the incoming data file (20) as having a structured, semi-structured or unstructured file type. In one embodiment, structured data refers to XML, EDI or other “tagged” data formats. In another embodiment, semi-structured data refers to ASCII, flat, positional or delimited file formats.

Referring to FIG. 2, if the incoming data file has an explicitly named structure, the named structure is used in conjunction with the incoming file (20) to break the file into records (22) and fields (24). Specifically, the processing unit (12) of the present invention determines which structure type is associated with the incoming data, as illustrated by Box (28) of FIG. 2. In one embodiment, the present invention maintains a library (not shown) to assist in identifying both the file type (26) and the structure type (28) of the incoming data file (20). To illustrate, an incoming XML file would first be identified by the present invention as having a structured file type (26). The present invention may then access the library to determine which structure type (28) is exhibited by the incoming file (20). In the present example, the processing unit (12) would determine that an XML structure type is utilized using information describing the attributes of XML files stored within the library.

Structured data sources provide syntactical and semantic information regarding the incoming file (20) through the inherent structure representation of the file. Accordingly, a high percentage of the syntactical and semantic information for structured incoming data files is automatically captured and utilized by the present invention upon being read into the system (10).

Referring to FIGS. 2 and 2A, once the file type (26) and structural type (28) have been determined, the processing unit (12) of the present invention analyzes the electronic data file (20) to identify the file's record break information, as illustrated by Box (30) of FIG. 2. In one embodiment, the present invention analyzes the structured file to identify record break characters (32) typically used with the pre-determined file type. In one embodiment, record break information (30) comprises demarcated record break characters (32) and/or character counts.

Utilizing the record break information (30) inherent within a structured file (20), the processing unit (12) parses the electronic data file (20) into one or more electronic data records (22). Data records (22) having substantially similar attributes are identified and matched by the processing unit (12), as illustrated by Box (34) of FIG. 2. In one embodiment, data records (22) are matched by comparing syntactic information residing within the data file (20). For example, character counts and common headings found within the incoming data file (20) may be used to denote substantially similar records (22).

Referring to FIGS. 2 and 2B, once individual records (22) have been identified, the processing unit (12) of the present invention analyzes each individual record (22) in order to identify field break information, as illustrated by Box (36) of FIG. 2. In one embodiment, field break information comprises demarcated field break characters (38) and/or transition points. The field break information (38) is utilized to parse data records (22) into individual data fields (24). The processing unit (12) of the present invention compares each individual data field (24) contained within previously matched records (22) to establish syntactic values for the entire data file (20), as illustrated by Box (62) of FIG. 2. The data analysis process may be repeated as many times as is necessary to determine each individual data record (22), field (24) and element, within the incoming data file (20), as illustrated by Box (60) of FIG. 2.

Referring to FIGS. 2A and 3, the present invention is capable of determining the structural characteristics of an incoming file (20) that has no explicitly named structure. To accomplish this, the present invention first determines the file type (26) at issue. Data files (20) having no explicitly named structure are read into the system for data analysis. The processing unit (12) of the present invention analyzes the incoming data file(s) (20) to identify record break information, as illustrated by Box (40) of FIG. 3. In one embodiment, record break information comprises one or more line termination characters (42) and/or character counts found within the data file (20). The record break information (40) is utilized to parse the electronic data file (20) into one or more electronic data records (22), as illustrated by Box (44). Data records (22) having substantially similar attributes are identified and matched by the processing unit (12) of the present invention. In one embodiment, data records (22) are matched by comparing syntactic information within the data file (20). For example, character counts and common headings found within the incoming data file may be used to denote substantially similar records, as illustrated by Box (44).

Referring to FIGS. 2B and 3, once individual records (22) have been identified, the processing unit (12) of the present invention analyzes each individual record (22) in order to identify field break information (46). In one embodiment, field break information (46) comprises character type transitions and/or character counts, as illustrated by Box (48) of FIG. 3. The field break information is utilized to parse data records into individual data fields. The processing unit (12) of the present invention compares each individual data field contained within previously matched records to ensure commonality between data fields, as illustrated by Box (50) of FIG. 3. As with data analysis of structural data files, the data analysis process for semi-structured or unstructured files may be repeated as many times as is necessary to determine each individual data record (22), field (24) and element (23) within the incoming data file (20), as illustrated by Box (70).

Referring to FIGS. 2 and 3, once data analysis is completed, records and fields are identified across all incoming data, as illustrated by Box (54). The structural patterns found during data analysis may then be used to create the output data (16) of the present invention. In one embodiment, the output data (16) created by the present invention contains a structural description of at least a portion of the analyzed data file(s) (20). In one embodiment, the present invention creates output data (16) describing the structural characteristics of the analyzed data file (20) or files as a whole.

Each output (16), as created by the present invention, provides a concise description of the analyzed data file(s) (20) providing the user with information about the analysis. This information includes the identification of record types present within the incoming file(s), the structure of each record, the sequence of record types, the cardinality of each record type, how records are grouped together and whether the records are optional, required, vary in count, or repeat according to a discernible pattern. In one embodiment, output data (16) is converted into a pre-selected computer intelligible language (i.e., XML) that may then be stored within the storage device (14) for later use.

In one embodiment, the present invention uses tokenized symbology to denote the structure of the analyzed data (20) as represented by the output data (16) of the present invention. The present invention analyzes the inherent structure of the incoming data (20). In one embodiment, once the structure of an incoming data file (20) has been determined, each analyzed data file is tokenized such that each unique record (22) and field (24) is defined. Once tokenized, the structural characteristics of the analyzed data are used to assign a symbolic identifier to each structural component of the data file (20). Thus, the analyzed data (20) file represented by the output data (16) of the present invention is assigned one or more tokenized symbols capable of symbolically representing the structural characteristics (16) of the analyzed data.

Data Organization

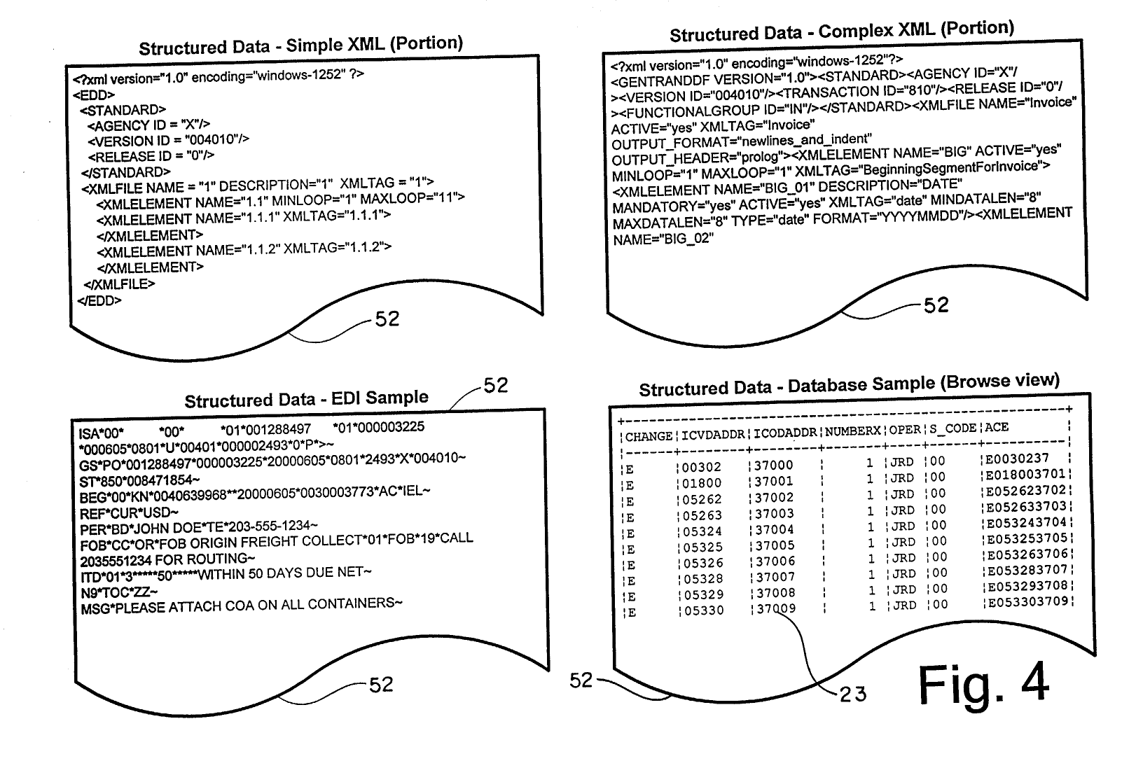

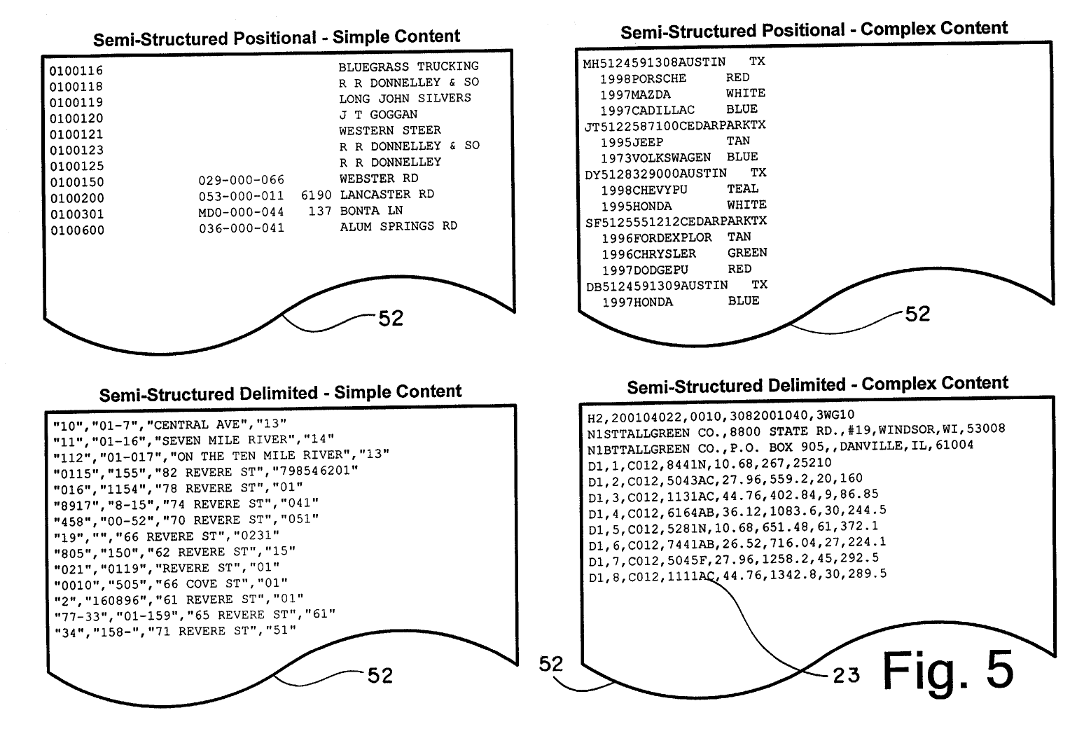

Referring to FIGS. 4 and 5, the present invention is capable of describing the relationship amongst and between each data element (23) within incoming data files (20). Specifically, the present invention is capable of generating a hierarchical representation (52) of each record (22) and field (24) within an analyzed data file (20). In one embodiment, each data element (23) is referred to as a node and each node is a direct descendent of a parent node. By identifying the parentage of each node, the present invention provides the user with a reference with which to determine and/or locate the source file from which each data element belongs, as illustrated by Box (11) of FIG. 1. In this manner, each data element (23) has a defined position within the hierarchy as well as a defined parentage, a specific organizational scheme and information from which the user may determine the data element's siblings, collections and/or children. For the purpose of illustration only, the following example of one of the naming conventions that may be used by the present invention is provided as follows.

In one embodiment, a multi-level decimal point notation system may be used to identify each file (20), record (22) and field (24). The decimal point notation system may also be valuable in providing unique identification values for each data element (23). For example, if the value “1” is used to describe a file (20) and all of its content, the first record of this file may be labeled “1.1” while the second record may be labeled “1.2”. Accordingly, the first field contained in the first record “1.1” would be labeled as “1.1.1” while the second field in the first record labeled as “1.2.1”.

In some cases, the data analysis process may indicate that a particular field (24) or record's (22) presence is optional and/or repeating. For example, an optional field or record may be designed to carry an additional alpha character notation that is needed only in special cases. For example, given two fields with node values of “1.2.3A” and “1.2.3B”, the user and/or the processing unit (12) of the present invention may quickly determine that field “3” in record “2” of file “1” may have two distinct, yet valid, entries.

In one embodiment, the present invention utilizes two methodologies to describe the hierarchy of nodes. The first methodology employed by one embodiment of the present invention utilizes a structural description. To illustrate, an incoming file (20) may have several repeating records (22) or fields (24) that are not useful in describing the structural characteristics of the file. In this example, the structural node description is designed to limit the scope of the data analysis process to the basic structure of the file (20), thus excluding the replication patterns of the above mentioned records (22) and/or fields (24). In this example, the practical result is that the structural description expresses only a single record instead of a plurality of repeating records or fields that do not provide the system with structural information.

A second methodology employed by one embodiment of the present invention utilizes a data sample node description. In one embodiment, the data sample node description displays each and every data element (23) within the selected file (20), without regard to repetition or redundancy. Specifically, this second methodology uses additional values in the node description to indicate the iteration number of any repeating records (22) or fields (24). For example, node value of “(1-1) 1.2.1” and “(1-2)1.2.1” would represent first and second iterations of a repeating field with the node value of “1.2.1”. In this example, “1.2.1” serves as a link between the simple structural description and the data sample description.

Modification

Referring to FIGS. 1, 4 and 5, a user interface (15) is provided by the present invention to allow the display of both the hierarchical representation (52) of the structural characteristics of the analyzed data file (20) and the specific semantic and syntactical information for each file, record (22) and field (24). In one embodiment, the hierarchical representation (52) is expressed as an expansion “tree” wherein the “root” denotes the file, the “branches” denote the records and the “leaves” denote the fields. The expansion tree is suited to express the nodes and may take advantage of the node methodologies described above. In one embodiment, node values describe the root/branch/leaf construct through the multi-level decimal point methodology.

In another embodiment, a detailed collection of tables is used to list the structural characteristics that may be reviewed and/or edited by the user. These values include, but are not limited to:

Minimum/Maximum Length

Minimum/Maximum Value

Justification

Format

Modified (True/False)

Mandatory (True/False)

Type (Alpha, Numeric, etc.)

User-Defined Name

The present invention allows the user to view the structural characteristics gleaned from the data analysis process and then modify same to achieve the proper results. Changes can be made to individual records (22) or fields (24) by the user, as desired.

In one embodiment, the user interface (15) of the present invention is designed to limit the displayed fields (24) to only those of the same type. For example, in a semi-structured file of addresses, one field typically denotes “CITY”. The display of this semi-structured file may be filtered to only the “CITY” data field, thus allowing the user to review the structural characteristics for that field (24). This feature of the present invention helps the user ensure that the automated data analysis process accurately identifies the “CITY” field elements across all records. In another embodiment, the list of “CITY” field elements is sorted alphabetically to allow for faster searching and review by the user.

Output

Referring to FIGS. 1, 2, 3 and 6, the present invention is capable of providing three types of output data. The first type of output data (16TD) employed in one embodiment of the present invention being output data designed for use by other applications intending to use data files (20) analyzed by the present invention for their own input. The second type of output data (16T) employed in one embodiment of the present invention being designed for use in generating different versions of one or more incoming data files (20). The third type of output data (16) employed in one embodiment of the present invention takes the form of generated data that describes the entire file and the data elements and structure.

In one embodiment, the first type of output data (16TD) of the present invention may be converted to an XML document as described above. The XML document is then used to parse and translate documents being fed into another system, such as an electronic commerce system. Structural characteristics are expressed within the XML document using normalized XML values and expressions to enable them to be read and utilized by any system capable of reading and processing an XML document. In short, the data analysis process of the present invention is used as a parse command generator, thus enabling a subsequent user to describe an incoming data file (20) to an external system.

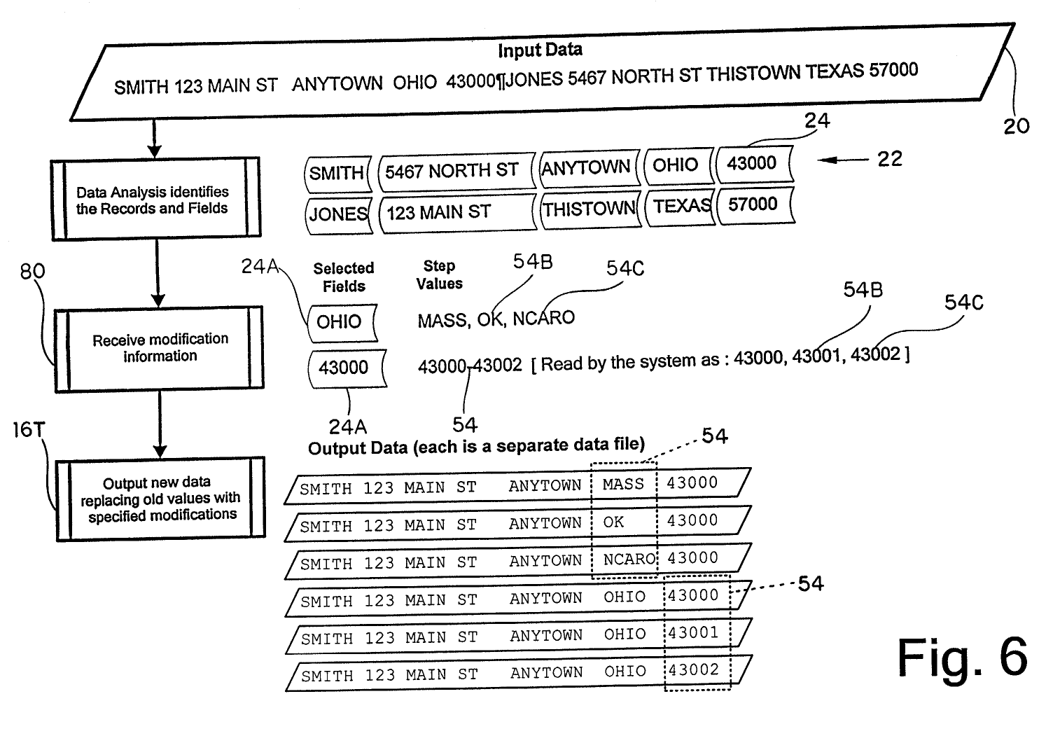

Referring to FIG. 6, in one embodiment, the second type of output data (16T) is a user managed collection of output data (16) capable of matching the original incoming data file (20) with the exception of one or more specific data fields (24A) containing user defined modifications (80). This collection of output data may then be used to evaluate how the system reacts to these minor changes. The present invention is data-centric in that it introduces no outside influences or presumptions to the generations of the collection of output data (16T). Specifically, all output data (16T) produced by the processing unit (12) of the present invention is sourced from the analyzed data files (20) and varies only according to specific modification information (80) as supplied by the user.

The present invention is capable of using the structural characteristics of analyzed files (20) to create a plurality of output data (16T) identical to the analyzed data file (20) with the exception of modified fields. Through the user interface (15), the user is given the opportunity to select specific values (54) that will be used within each individual field (24) within the output data. In one embodiment, the resulting output data (16T) utilize the original values of the incoming data file(s) for all records (22) and fields (24) with the exception of a predetermined data field (24A). The value (54) of this predetermined field (24A) is entered by the user as a modification instruction (80). In one embodiment, if the modified field (24A) has more than one value (54) entered by the user, the next output, or set of output, will use the second value (54B) from the user's entry, then the third (54C), etc., until all of the user's values (54) have been used to produce output data (16).

Modification information (80) may take virtually any type (i.e., alpha, numeric, time, date, etc.) or format as desired by the user. The present invention allows for the generation of output data (16) that can purposefully fail, and through this failure, invoke additional error handling programming. Accordingly, the present invention does not attempt to evaluate the impact (likely success or failure of subsequent processing) of the user's modification. For example, it is possible for the user to place characters into a numeric field for the purpose of causing expected error when the output data(s) is parsed during subsequent processing. In one embodiment, the modification of one or more fields (24) by the user, accumulated across substantially all fields in an analyzed data file (20), may be used to generate output data (16) differentiated according to the modified field (24A) only. To provide the user with convenient entry of modification information (80), one embodiment of the present invention provides Field Increment Value Setting (FIVS).

The FIVS process of the present invention allows the user to manage numerical range values which describe some collection of values for user modifications. For example, the user value “1-5” is equal to entering user values of “1, 2, 3, 4, 5”, and will generate five output data files (16T). To further illustrate, “1-1000” will generate one thousand sets of output data, differing according to the user's modification instructions one thousand times. In addition to simple ranging, the present invention allows the user to provide step increments as well. For example, the user value “0-4; 2” would be interpreted to be equivalent to entering “0,2,4” since the number following the semi-colon describes the size of the step increment. Step increments may also be sub-integer in value, where “0-4;.5” would be interpreted as entering “0, .5, 1, 1.5, 2, 2.5, 3, 3.5, 4”.

In another embodiment, data formatting is also provided within the FIVS process. For example, the user value “5-7: 000” is interpreted to be equivalent to entering user values of “005, 006, 007” where the characters following the colon describe the character filled format of the output field value. Additionally, other data may be prepended or appended to the ranged values in an FIVS command. For example, the user value “FIRST_{—}”1-3”_LAST will output FIRST_{—}1_LAST, FIRST_{—}2_LAST and FIRST_{—}3_LAST. In one embodiment of the present invention, a special type of FIVS value is provided for use in management of mandatory unique identifiers for each set of output data (16), hereinafter referred to as the Trans-Session Unique Naming System (T-SUNS).

T-SUNS allows the user to designate which field(s) (24) will be modified for each set of output data (16). T-SUNS is an improvement upon FIVS. Specifically, FIVS is capable of understanding single fields (24) and the set or range of values (54) that the user intends for FIVS to place in modified fields (24A) during output data (16) generation. However, output data (16) is typically used for processing within an external system. This means that the external system may require each document to be equipped with a unique identification number.

T-SUNS accommodates this requirement through a triggering command (not shown) entered by the user during the FIVS process for a predetermined data field or fields. In one embodiment, the triggering command instructs the system to insert a new value for the field (24) or fields having an attached triggering command. This new value may then be used as a unique identifier to not only the modified data fields but also for the analyzed data from which the output data (16) is created. The present invention uses structural information to accomplish this. By maintaining information regarding the structural characteristics of the field(s) (24) to which a unique identification has been assigned, the present invention is capable of generating the unique number when required for any and all output data (16) containing fields (24) with an attached triggering command.

In one embodiment, the unique identification number consists of a preamble, amble and postamble. The present invention allows the user to edit the identification number as desired. In one embodiment, the user may edit the preamble and postambles as desired as well as set the starting value and format for the amble portion. For example, a typical use for unique identification numbers is for purchase orders. This type of document typically uses numeric counters surrounded by alphabetic characters and formatted with leading 0's. To illustrate, a purchase order number of XYZ0001PO may be managed within the T-SUNS process as XYZ for the preamble, 1:0000 as the amble and PO as the postamble. Starting with these values, T-SUNS would return XYZ0001PO the first time, XYZ0002PO the second time, and so on. Since the structural characteristics are used for the preamble, amble and postamble, subsequent output data (16), even if produced subsequently, are capable of using the next available increment of the identification number as long as the original output data's (16) structural characteristics still apply.

In addition to the above, the present invention is capable of automatically modifying output data (16) through the use of the Field Instance Bounds Generation (FIBG) process. Unlike FIVS where the user enters all data modification instructions (80), FIBG uses the structural characteristics of the output data (16) to determine the boundaries of valid data for selected fields (24A). Once this is accomplished, the FIBG process of the present invention “pushes” the boundaries. For example, FIBG is capable of producing output data (16) based on the following boundaries.

A first boundary employed by one embodiment of the present invention is referred to as minimum minus. Minimum minus tests use the structural characteristics of the output data (16) to determine the minimum value for a given field (24). In one embodiment, output data (16) includes a first value that meets the predetermined minimum value as well as a second value that decrements the first value by a factor of one. Thus, the present invention may presume that output data (16) having the first value which meets the predetermined minimum value will pass subsequent processing (e.g., a positive test) while the output data (16) having the second value that does not meet the predetermined minimum value with not pass subsequent processing (e.g., a negative test). In one embodiment, the presumption of success or failure is indicated in the naming convention for each set of output data (16) to provide the user with simplified review and identification of each set of output data.

A second boundary employed by one embodiment of the present invention is referred to as maximum plus. Maximum plus uses the structural characteristics to determine the maximum value in order to output one data set for each field (24) that meets the maximum plus value, as well as one data set for each field that exceed the maximum plus value. In one embodiment, the presumption of success or failure is indicated in the naming convention for each set of output data (16) to provide the user with simplified review and identification of each set of output data.

A third boundary employed by one embodiment of the present invention is referred to as blank field. Using this boundary, blank spaces, instead of alphanumeric characters, are used for the predetermined field. A fourth boundary employed by one embodiment of the present invention is referred to as field type. Field type uses the structural characteristics of the field type at issue so that each field may be varied. For example, typical field types include alpha, numeric and alphanumeric. Fields marked for this type of output data generation will produce three data sets, one with all alpha characters, one with only numeric characters, and one with mixed alphanumeric characters. In one embodiment, the presumption of success or failure is based on the field type at issue.

A fifth boundary employed by one embodiment of the present invention is referred to as decimal count. Decimal count is utilized primarily in conjunction with fields (24) that indicate a numeric type or have a predefined decimal format. FIBG output data (16) having these fields will increment and decrement the decimal position for the field's data. The presumption of success or failure is based on the existing decimal format for the field, with any matching format assuming success, and any deviation from the standard format assuming failure.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

We claim:

1. A computer implemented method of analyzing electronic data comprising the steps of:
a) providing a processing unit capable of receiving electronic data;
b) further providing a storage device coupled to said processing unit;
c) accessing one or more electronic data files, each said data file having a structure;
d) analyzing said one or more electronic data files to identify record break information contained therein;
e) utilizing said record break information, parsing said one or more data files into one or more electronic data records;
f) analyzing each of said electronic data records to identify field break information contained therein;
g) utilizing said field break information, parsing each of said data records into one or more data fields; and,
h) generating output data describing said structure of said one or more electronic data files.

2. The method of claim 1, further comprising the steps of:
repeating steps d) through g); and
utilizing said record break information and said field break information, updating said output data.

3. The method of claim 1 or 2, further comprising the step of:
storing said output data within said storage device.

4. The method of claim 1, further comprising the step of:
assigning a tokenized symbolic identifier to one or more of said data fields.

5. The method of claim 1, further comprising the step of:
providing a user interface through which a user may modify said output data, said user interface coupled to said storage device.

6. The method of claim 1, further comprising the step of:
utilizing said output data, generating a translation document capable of translating electronic documents into one or more predefined formats.

7. The method of claim 1, further comprising the steps of:
receiving modification instructions;
applying said modification instructions to one or more of said data fields; and
generating a first plurality of data files containing one or more modified data fields.

8. The method of claim 7, further comprising the step of:
testing said first plurality of data files.

9. The method of claim 1, further comprising the step of:
identifying a file type associated with each of said electronic data files.

10. The method of claim 1, further comprising the step of:
combining substantially similar electronic data files.

11. The method of claim 1, further comprising the steps of:
identifying one or more types of said electronic data records; and
analyzing said record type of each of said electronic data records to determine a degree of similarity.

12. The method of claim 11, further comprising the step of:
determining a cardinality for each said record type.

13. The method of claim 11, further comprising the step of: determining a sequence of representation for each said record type.

14. The method of claim 11, further comprising the step of:
representing said degree of similarity of each said record type within said output data.

15. The method of claim 12, further comprising the step of:
representing said cardinality of each said record type within said data file.

16. The method of claim 13, further comprising the step of:
representing said sequence of representation for each said record type within said data file.

17. A computer readable medium comprising a plurality of instructions for analyzing computer intelligible electronic data which, when read by a computer system having a processing unit capable of receiving electronic data coupled to a storage device capable of storing electronic data, causes the computer to perform the steps of:
a) accessing one or more electronic data files, each said data file having a structure;
b) analyzing said one or more electronic data files to identify record break information contained therein;
c) utilizing said record break information, parsing said one or more data files into one or more electronic data records;
d) analyzing each of said electronic data records to identify field break information contained therein;
e) utilizing said field break information, parsing each of said data records into one or more data fields;
f) generating output data describing said structure of said one or more electronic data files; and,

18. The medium of claim 17, wherein said plurality of instructions causes the computer to perform the additional steps of:
repeating steps b) through e);
utilizing said record break information and said field break information, updating said output data.

19. The medium of claim 17 or 18, further comprising the step of:
storing said output data within said storage device.

20. The medium of claim 17, wherein said plurality of instructions causes the computer to perform the additional step of:
assigning a tokenized symbolic identifier to one or more of said data fields.

21. The medium of claim 17, wherein said plurality of instructions causes the computer to perform the additional step of:
providing a user interface through which a user may modify said output data, said user interface coupled to said storage device.

22. The medium of claim 17, wherein said plurality of instructions causes the computer to perform the additional step of:
utilizing said output data, generating a translation document capable of translating electronic documents into one or more predefined formats.

23. The medium of claim 17, wherein said plurality of instructions causes the computer to perform the additional steps of:
receiving modification instructions;
applying said modification instructions to one or more of said data fields; and
generating a first plurality of data files containing one or more modified data fields.

24. The medium of claim 23, wherein said plurality of instructions causes the computer to perform the additional step of:
testing said first plurality of data files.

25. The medium of claim 17, wherein said plurality of instructions causes the computer to perform the additional step of:
identifying a file type associated with each of said electronic data files.

26. The medium of claim 17, wherein said plurality of instructions causes the computer to perform the additional step of:
combining substantially similar electronic data files.

27. The medium of claim 17, further comprising the steps of:
identifying one or more types of said electronic data records; and
analyzing said record type of each of said electronic data records to determine a degree of similarity.

28. The medium of claim 27, further comprising the step of:
determining a cardinality for each said record type.

29. The method of claim 27, further comprising the step of:
determining a sequence of representation for each said record type.

30. The method of claim 27, further comprising the step of:
representing said degree of similarity of each said record type within said output data.

31. The method of claim 28, further comprising the step of:
representing said cardinality of each said record type within said data file.

32. The method of claim 29, further comprising the step of:
representing said sequence of representation for each said record type within said data file.

33. A computer system for analyzing computer intelligible electronic data comprising:
a processing unit for accessing one or more electronic data files, each said data file having a structure, for analyzing said one or more electronic data files to identify record break information contained within said files, for parsing said one or more data files into one or more electronic data records according to said record break information, for analyzing each of said electronic data records to identify field break information contained within said records, for parsing each of said data records into one or more data fields according to said field break information and for generating or output data describing said structure of said one or more electronic data files.

34. The computer system of claim 33, wherein said processing unit is further defined as being capable of updating said output data.

35. The computer system of claim 33, wherein said computer system further comprises a storage device, said processing unit being capable of storing said output data within said storage device.

36. The computer system of claim 33, wherein said processing unit is further defined as being capable of assigning a tokenized symbolic identifier to one or more of said electronic data fields.

37. The computer system of claim 33, wherein said computer system further comprises an interface through which a user may modify said output data, said interface being coupled to said processing unit.

38. The computer system of claim 33, wherein said processing unit is further defined as being capable of generating a translation document capable of translating electronic data into one or more predefined formats.

39. The computer system of claim 33, wherein said processing unit is further defined as being capable of receiving modification instructions, applying said modification instructions to one or more of said data fields and generating a first plurality of data files containing one or more modified data fields.

40. The computer system of claim 39, wherein said processing unit is further defined as being capable of testing said first plurality of data files.

41. The computer system of claim 33, wherein said processing unit is further defined as being capable of identifying a file type associated with each of said electronic data files.

42. The computer system of claim 33, wherein said processing unit is further defined as being capable of combining a first plurality of said electronic data files having a substantially similar structure.

43. The computer system of claim 33, wherein said record break information comprises one or more line termination characters.

44. The computer system of claim 33, wherein said record break information comprises one or more record break characters.

45. The computer system of claim 33, wherein said field break information comprises one or more character type transitions.

46. The computer system of claim 33, wherein said field break information comprises one or more character counts.

47. The computer system of claim 33, wherein said processing unit is further defined as being capable of identifying one or more types of said electronic data records and analyzing said types of said electronic data records to determine a degree of similarity.

48. The computer system of claim 47, wherein said processing unit is further defined as being capable of determining a cardinality for each said record type.

49. The computer system of claim 47, wherein said processing unit is further defined as being capable of determining a sequence of representation for each said record type.

50. The computer system of claim 47, wherein said processing unit is further defined as being capable of representing said degree of similarity of each said record type within said output data.

51. The computer system of claim 48, wherein said processing unit is further defined as being capable of representing said cardinality of each said record type within said data file.

52. The computer system of claim 49, wherein said processing unit is further defined as being capable of representing said sequence of representation for each said record type within said data file.
